(19) United States
(12) Patent Application Publication
(10) Pub. No.: US 2011/0226555 A1
(43) Pub. Date: Sep. 22, 2011

(54) WHEEL ARM DISPLACING CENTER OF GRAVITY

(76) Inventors: Ramazan Eryildiz, Elazig (TR); Hikmet Kosar, Elazig (TR); Hikmet Dogan, Elazig (TR)

(21) Appl. No.: 13/121,329

(22) PCT Filed: Sep. 17, 2009
(86) PCT No.: PCT/IB2009/054066

§ 371 Date: May 24, 2011

(30) Foreign Application Priority Data
Sep. 26, 2008 (TR) 2008/07424

(51) Int. Cl. F03G 3/06

(52) U.S. Cl. 185/29

(57) ABSTRACT

The present invention relates to weight being imposed onto an arm adapted to oscillate in connection with the wheel and thus to movement of the wheel upon displacement of the center of gravity. The objective of the present invention is to provide a wheel arm for pushing forward a weight coupled to the wheel hub whereby changing center of gravity of the system.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to weight being imposed onto an arm adapted to oscillate in connection with the wheel, and thus to movement of the wheel upon displacement of the center of gravity.

2. Description of Related Art Including Information Disclosed Under 37 CFR 1.97 and 37 CFR 1.98.

In the state of the art transportation systems, the actuation point is the shaft in the wheel. Movement is enabled by transmitting the force directly to the wheel. Engines with high power are required to move vehicles and these engines cannot consume fuel efficiently Innovations on vehicles are generally made by producing alternative solutions for safety, comfort or fuel.

The United States patent document U.S. Pat. No. 5,090,260, an application in the state of the art, discloses a gyrostat thrust system. In the said system, a gyrostat is mounted on a vehicle with wheels. The gyrostat generates momentum when spinning The momentum in “y” direction enables the vehicle to move only in that direction. The said system provides another solution for movement of the vehicle other than an internal combustion engine.

The French patent document FR2567202, another application in the state of the art, discloses an inertial propulsion system. In the said system, center of gravity of the wheel is driven in a semi-circular movement whereby the wheel is advanced.

The patent document WO 03/083296 A1, another application in the state of the art, discloses a dynamic wheel group having moment difference. Per the abstract: “The invention relates to a dynamic wheel group having moment difference, it combines the physical fundamental with the lever mechanism, and it can transform energy. The force caused by the object's weight or volume acts as the force of initial moment in the lever mechanism. In each dynamic wheel element of the lever mechanism, the initial moment is transformed into the ultimate moment via coupling action and lever fundamental, and the objects move to a positive work point from a negative work point. The line of zero moment is offset, so all ultimate moment and the initial moment out of a certain range are collected to give a net moment, and the rotary energy can be transformed into the output energy.”

The patent document DE 197 38 680 A1, another application in the state of the art, discloses a drive mechanism with flywheels for driving slow-running machines. Per the abstract “the mechanism is driven by an engine whose inertia rotor is unbalanced to increase torque. The rotor works with a driven machine absorbing the total torque. Between parallel vertical or horizontal rotors (2,6) supporting an inertia weight is a generator forming the narrow driven machine (4) and which is roughly of the same external diameter (A). This forms a slow-running annular electric generator, and has a direct rotary joint to each rotor. One or more pairs of rotors turn in opposite directions in a stabilizing frame (8), and each has a spring mechanism (10,12) controlling and actuating a diametral system. The spring mechanism has an electromagnetic controller, together with a hydraulic or pneumatic pressure source actuating a working piston. During one part of the rotary movement of the rotor the spring mechanism exerts a force aiding rotation, while during another, the rotors being preferably mounted vertically, aid is provided by gravity by the inertia weight.”

The United States patent document US2007/034042 A1, an application in the state of the art, discloses a rotational movement generating and amplifying apparatus comprising a first disk of a first radius; a rotating first rod protruding upward from the first disk; and a rotational assembly having a first elongated plate member, second elongated plate member, and second disk.

The patent document WO 03/069157 A1, another application in the state of the art, discloses a torque- or energy-producing device. The invention relates to a device which combines the use of: a lever arm (L), one end thereof being articulated around a point (A); and a jack-type device (V), one end of said jack being articulated around a point (B) and the other end thereof being articulated to an intermediary point (C) on the lever arm (L) by means of a slide attachment.

### BRIEF SUMMARY OF THE INVENTION

The objective of the present invention is to provide a wheel arm (1) for pushing forward a weight coupled to the wheel hub whereby changing center of gravity of the system.

### BRIEF DESCRIPTION OF THE DRAWINGS

The “Wheel Arm Displacing Center of Gravity” realized to fulfill the objective of the present invention is illustrated in the accompanying figures, in which:

FIG. 1 is a front view of the inventive wheel arm (normal position-position 1);

FIG. 2 is a front view of the inventive wheel arm upon which a force is applied (the position when force is applied);

FIG. 3 is a perspective view of the inventive wheel arm (normal position-position 1);

FIG. 4 is a perspective view of the inventive wheel arm upon which a force is applied (the position when force applied);

FIG. 5 is a perspective view of the inventive wheel arm on which is a builded prototype;

FIG. 6 is a perspective view of the second position of the inventive wheel arm on which is builded prototype; and

FIG. 7 is a perspective view of the third position of the inventive wheel arm on which is builded prototype.

The components shown in the figures are numbered as follows:

1. Wheel arm

2. Wheel

3. Shaft

4. Arm

5. Frame

6. Connecting Member

7. Small toothed wheel

8. Big toothed wheel

9. Engine

### DETAILED DESCRIPTION OF THE INVENTION

The inventive wheel arm (1) comprises a wheel (2) enabling movement of the vehicles. A shaft (3) is disposed in the inner part of the wheel; An arm (4) which is connected to the shaft (3), onto which the weight is transmitted by the force applied and enables displacement of the center of gravity; A frame (5) is provided to which the arm is coupled (4); At least one connecting member (6) enables the arm (4) to be coupled to the shaft (3) and the frame (5).

In the wheel arm (1), the force is not applied to the wheel (2) but to the center of gravity. The arm (4) carrying the weight and coupled to the wheel shaft (3) is advanced whereby center of gravity is displaced. As the center of gravity is advanced, the wheel (2) is rolled forward. Hence the weight is carried by much less energy and the vehicle moves.

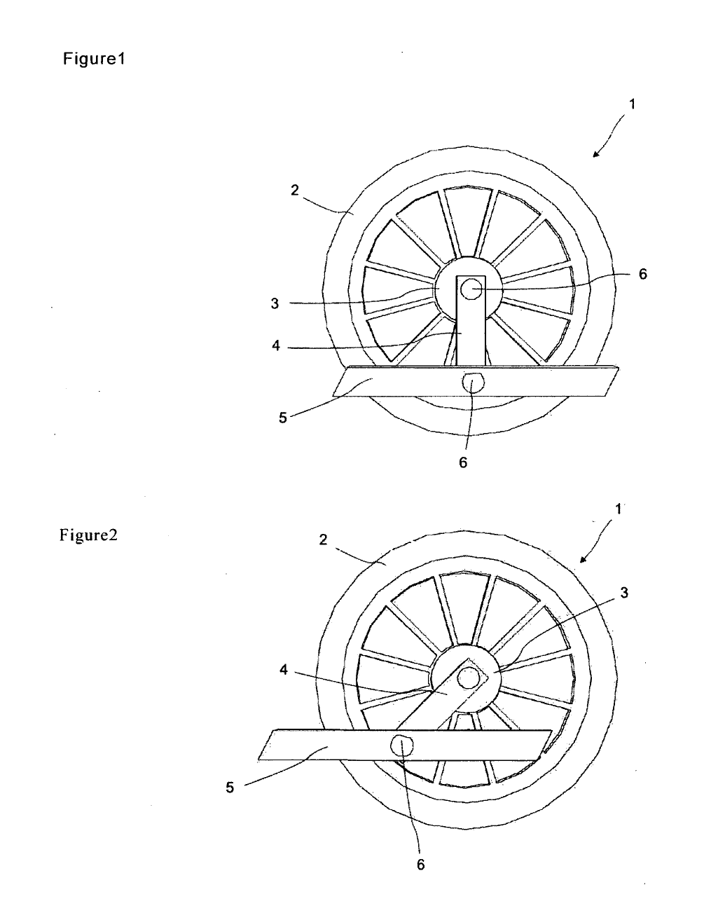

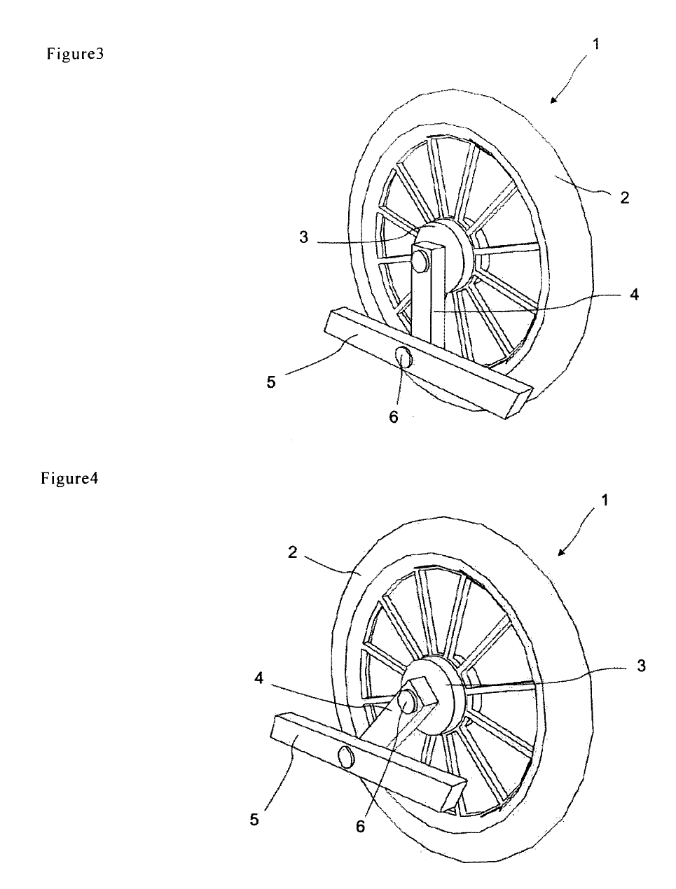

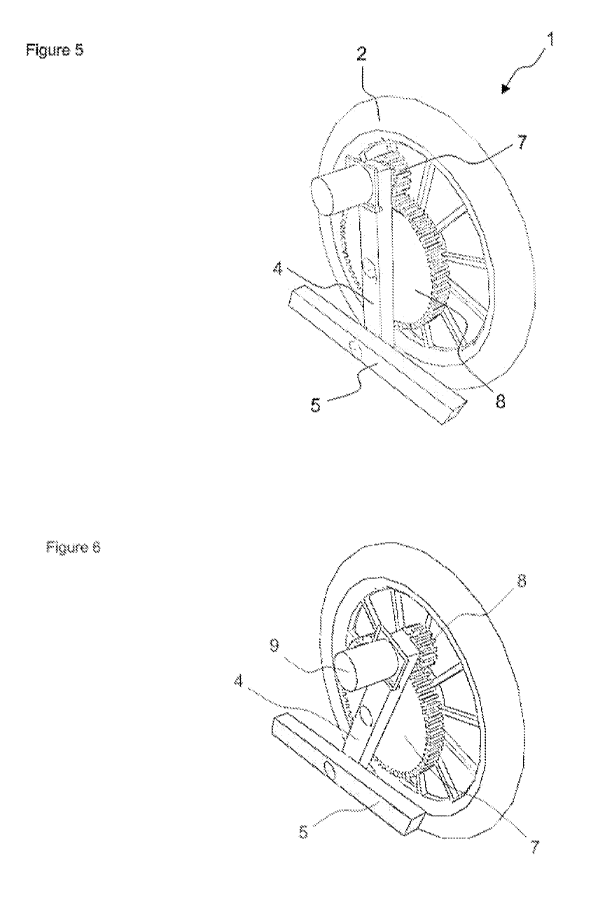

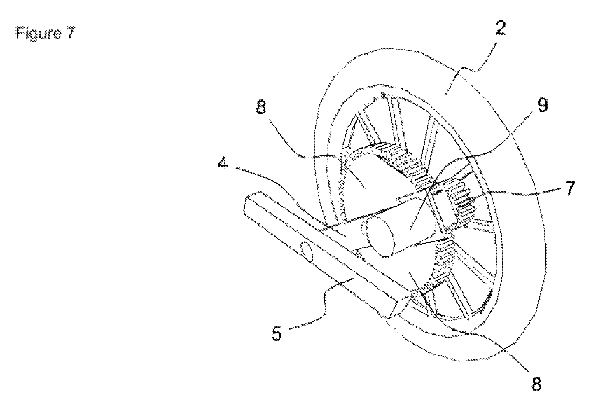

The system operates with the principle of rolling of the wheel (2) (going back to its old position) as a result of angular displacement of the place of the wheel (2) center of gravity (frame (5)) weight applied on the wheel) with the help of a coupled arm (4) when a force is applied (by an engine etc. power) on the arm (4) as seen in FIG. 1, FIG. 2, FIG. 3, and FIG. 4. In FIG. 5, FIG. 6, and FIG. 7, the application of the system is shown in the prototype made by the inventors. While the small toothed wheel (7) (pinion) connected to the engine (9) moves toward the right side on the large toothed wheel (8) connected to the wheel (2), the arm (4) and the frame (5) in connection to this arm (4) move towards the left side in a way that they would form an angle (the 2nd and the 3rd positions according to the speed and the power of the engine). The wheel (2) is rolls towards the left side in order to reach its first position (1st position (FIG. 5)) and thus moves towards that direction.

The force applied onto the arm (4) coupled to the shaft (3) can be applied by means of a gear, chain or belt system that may be arranged on the wheel (2), shaft (3) or arm (4). The center of gravity is changed by the force applied and the wheel (2) is moved by being rotated forward. The displaced center of gravity returns to its position upon rolling of the wheel (2). Continuous displacement of center of 15 gravity and its returning to its position produce movement of the wheel (2). The bigger the diameter of the wheel (2), the longer will be the distance traveled although the force applied remains the same.

Since less force is applied on the vehicle by means of the arm (4) located on the 20 wheel (2), the fuel consumed by the vehicle decreases. Thus vehicles function more efficiently.

The inventive “Wheel Arm Displacing Center of Gravity” is described by way of examples and illustrated with figures in order to facilitate better understanding thereof. However scope of the invention can not be limited to these examples and figures. It is possible for a person skilled in the art to develop other embodiments within the framework of the basic principles of the invention. The scope of the invention is essentially according to the claims.

1. A wheel arm comprising a wheel enabling movement of vehicles; a shaft is disposed in the inner part of the wheel; a frame is provided to which the arm is coupled; and at least one connecting member providing connection to the shaft and the frame; characterized by an arm which is connected to the shaft, onto which the weight is transmitted by the force applied and which enables displacement of the center of gravity.

2. A wheel arm according to claim 1, characterized in that the force applied onto the arm coupled to the shaft is provided by means of a gear system mounted on the wheel.

3. A wheel arm according to claim 1, characterized in that the force applied onto the arm coupled to the shaft is provided by means of a chain system mounted on the wheel.

4. A wheel arm according to claim 1, characterized in that the force applied onto the arm coupled to the shaft is provided by means of a belt system mounted on the wheel.

5. A wheel arm according to claim 1, characterized in that the force applied onto the arm coupled to the shaft is provided by means of a gear system mounted on the shaft.

6. A wheel arm according to claim 1, characterized in that the force applied onto the arm coupled to the shaft is provided by means of a chain system mounted on the shaft.

7. A wheel arm according to claim 1, characterized in that the force applied onto the arm coupled to the shaft is provided by means of a belt system mounted on the shaft.

8. A wheel arm according to claim 1, characterized in that the force applied onto the arm coupled to the shaft is provided by means of a gear system mounted on the arm.

9. A wheel arm according to claim 1, characterized in that the force applied onto the arm coupled to the shaft is provided by means of a chain system mounted on the arm.

10. A wheel arm according to claim 1, characterized in that the force applied onto the arm coupled to the shaft is provided by means of a belt system mounted on the arm.
